(19) United States
(12) Patent Application Publication
(10) Pub. No.: US 2024/0246343 A1
(43) Pub. Date: Jul. 25, 2024

(54) LIQUID DISCHARGE APPARATUS AND CONTROL METHOD

(71) Applicant: CANON KABUSHIKI KAISHA, Tokyo (JP)

(72) Inventors: AKIHIRO TOMIDA, Kanagawa (JP); TOSHIMITSU DANZUKA, Tokyo (JP); KEITA ISHIMI, Kanagawa (JP); TAKAO OGATA, Tokyo (JP); RIE TAKEKOSHI, Kanagawa (JP); AKIKO AICHI, Tokyo (JP)

(21) Appl. No.: 18/399,572

(22) Filed: Dec. 28, 2023

(30) Foreign Application Priority Data
Jan. 25, 2023 (JP) 2023-009725

(51) Int. Cl. B41J 2/18; B41J 2/045; B41J 2/165; B41J 2/175

(52) U.S. Cl. CPC B41J 2/18; B41J 2/0451; B41J 2/04553; B41J 2/04566; B41J 2/0458; B41J 2/16505; B41J 2/17596

(57) ABSTRACT

It is intended to excellently maintain a discharge characteristic of a discharge head. A liquid discharge apparatus includes a discharge head including a nozzle for discharging liquid, a circulation unit capable of circulating liquid through a circulation flow path including the discharge head, a cap unit capable of capping a nozzle surface of the discharge head where the nozzle is formed, and a control unit for controlling the discharge head, the circulation unit, and the cap unit. In a case where anomaly is detected and the cap unit cannot cap the nozzle surface, the control unit causes the circulation unit to circulate liquid through the circulation flow path.

### BACKGROUND

### Field of the Disclosure

The present disclosure relates to a liquid discharge apparatus and a control method.

### Description of the Related Art

In a liquid discharge apparatus capable of performing printing while discharging liquid (for example, ink), the viscosity of liquid increases in the vicinity of a nozzle formed at a discharge head as water in the liquid evaporates from the nozzle, and a problem potentially occurs when the liquid is discharged from the nozzle. In particular, as water evaporates liquid containing a large amount of solid content, the solid content condenses and thickens near the nozzle and it potentially becomes difficult to discharge the liquid from the nozzle. Even when the nozzle being blocked by the agglomerated solid content is pressurized by using a recovery mechanism or the like, it potentially unable to discharge the liquid.

In a method as a measure for such a problem, a supply flow path for supplying liquid and a collection flow path for collecting liquid are formed to circulate liquid between a liquid chamber in the discharge head and the nozzle. With this method, thickened liquid can be discharged from the nozzle and replaced with non-thickened liquid.

Japanese Patent Laid-Open No. 2021-169224 discloses a printing apparatus configured to obtain a time period in which printing operation is not performed and circulate liquid in the nozzle in a case where the time period exceeds a predetermined time period.

However, in the printing apparatus of Japanese Patent Laid-Open No. 2021-169224, a nozzle surface needs to be capped to circulate liquid. Thus, in a case where the discharge head stops in a region other than a standby position for some reason and the nozzle surface is continuously not capped, it is difficult to excellently maintain discharge characteristics of the discharge head in the printing apparatus of Japanese Patent Laid-Open No. 2021-169224.

Thus, a liquid discharge apparatus in the present disclosure is intended to excellently maintain discharge characteristics of a discharge head.

### SUMMARY

A liquid discharge apparatus comprising, a discharge head including a nozzle for discharging liquid, an energy generation element for generating energy used to discharge liquid, and a pressure chamber that is a space facing the energy generation element, a circulation unit configured to circulate liquid through a circulation flow path including the pressure chamber of the discharge head, a cap unit configured to cap a nozzle surface of the discharge head where the nozzle is formed; and a control unit for controlling the discharge head and the circulation unit, wherein in a case where anomaly is detected during discharge operation of the discharge head and the cap unit cannot cap the nozzle surface, the control unit causes the circulation unit to circulate liquid through the circulation flow path, and in a case where anomaly is detected during discharge operation of the discharge head and the cap unit can cap the nozzle surface, the control unit does not cause the circulation unit to circulate ink through the circulation flow path.

Further features of the present disclosure will become apparent from the following description of exemplary embodiments with reference to the attached drawings.

### BRIEF DESCRIPTION OF THE DRAWINGS

FIG. 1 is an external perspective view of a liquid discharge apparatus in an embodiment;

FIG. 2 is a block diagram illustrating an example of the configuration of a printing control system in an embodiment;

FIG. 3 is an exploded perspective view of a discharge head in an embodiment;

FIG. 4 is a diagram illustrating an example of the configuration of flow paths in an embodiment;

FIG. 5 is a schematic diagram illustrating an example of a circulation flow path in an embodiment;

FIG. 6 is a diagram for description of the configuration of a recovery mechanism in an embodiment;

FIGS. 7A to 7F are diagrams schematically illustrating a situation in which water evaporates in the vicinity of a nozzle;

FIG. 8 is a graph illustrating the relation between the ratio of water in liquid and elapsed time;

FIG. 9 is a diagram illustrating an example of a table in an embodiment;

FIG. 10 is a diagram illustrating an example of a flowchart in an embodiment;

FIG. 11 is a diagram illustrating the contents of recovery operation in an embodiment; and

FIG. 12 is a schematic diagram illustrating an example of the circulation flow path in an embodiment.

### DESCRIPTION OF THE EMBODIMENTS

In the following description, “printing” is not limited to formation of meaningful information such as characters and figures but may be or not meaningful. Moreover, “printing” is not limited to formation of information actualized to be visually perceptible by a human being but widely includes formation of images, marks, patterns, structures, and the like on a printing medium and also includes fabrication of a medium.

### Overview of Configuration and Printing Operation of Liquid Discharge Apparatus 100

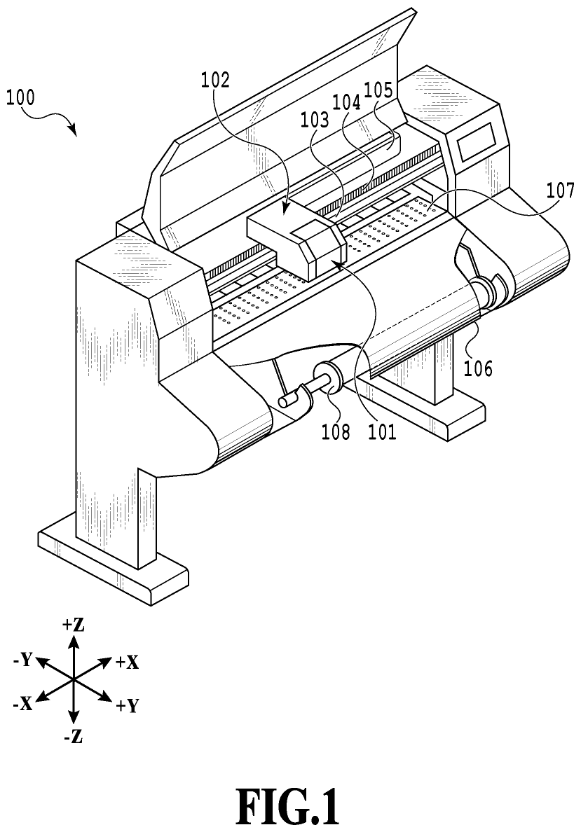

FIG. 1 is an external perspective view of a liquid discharge apparatus 100 in the present embodiment.

In diagrams referred in the present specification, an X direction and a Y direction are defined to be two directions orthogonal to each other on a horizontal plane. A Z direction is defined to be the vertical direction. The positive Y direction corresponds to the front side of the liquid discharge apparatus 100, the negative Y direction corresponds to the back side thereof, the negative X direction corresponds to the left side thereof, the positive X direction corresponds to the right side, the positive Z direction corresponds to the upper side thereof, and the negative Z direction corresponds to the lower side thereof. In the following description, the upper, lower, right, and left sides are directions when viewed from the front side of the liquid discharge apparatus 100 in a posture of being used in a normal state, unless otherwise stated.

As illustrated in FIG. 1, the liquid discharge apparatus 100 includes a discharge head 101 capable of performing printing while discharging liquid (for example, ink), and a carriage 102 to which the discharge head 101 is detachably attachable. The liquid discharge apparatus 100 includes a guide shaft 103 to which the carriage 102 is attached, and an encoder 104 for obtaining the position of the discharge head 101. The liquid discharge apparatus 100 includes a supply tube 105 for supplying liquid to the discharge head 101, a platen 107 capable of supporting a printing medium 106, and a spool 108 capable of winding and holding the printing medium 106.

The present embodiment will be described below by assuming a case where the printing medium 106 is a long paper roll. The description also assumes a case where the liquid discharge apparatus 100 is a serial-scanning-type printer using an ink jet printing scheme.

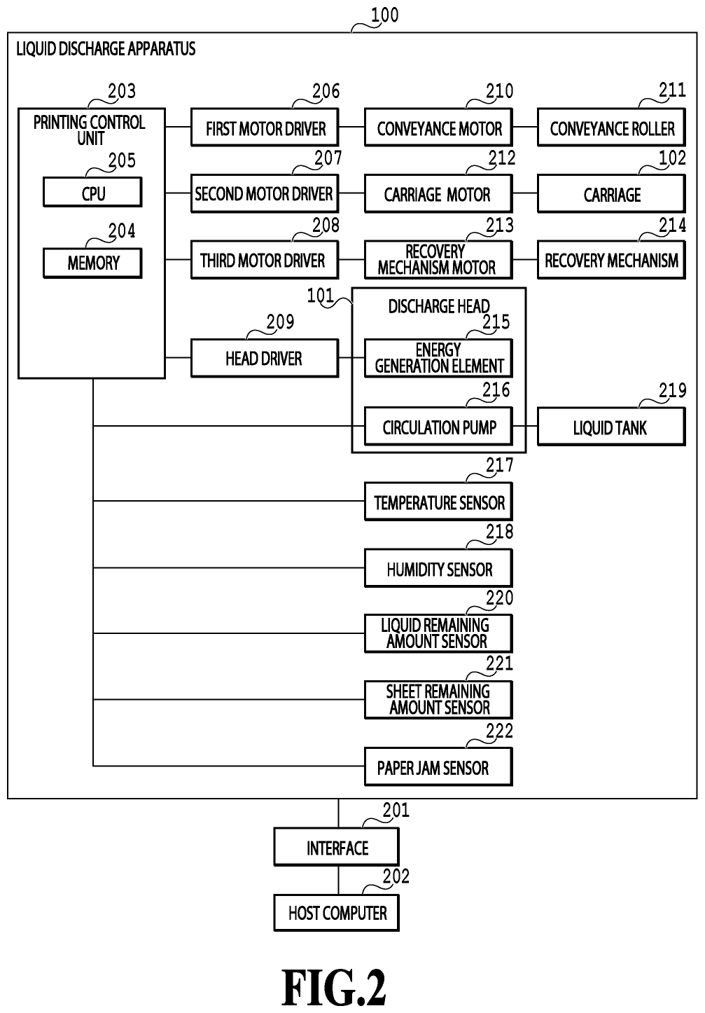

Operation of the liquid discharge apparatus 100 is performed under control by a printing control unit 203 (refer to FIG. 2). The spool 108 can hold the printing medium 106. The printing medium 106 held by the spool 108 is conveyed in a conveyance direction (the positive Y direction) by a conveyance roller 211 (refer to FIG. 2) driven through gears by a motor (not illustrated) for feed roller drive.

The carriage 102 is subjected to reciprocate scanning (reciprocate movement) along the guide shaft 103, which extends in a main scanning direction intersecting the conveyance direction, in accordance with the conveyance of the printing medium 106 by a carriage motor 212 (refer to FIG. 2) for driving the carriage 102. The conveyance direction is the positive Y direction in FIG. 1, and the main scanning direction is the X direction in FIG. 1.

Then, in the process of the scanning, discharge operation of liquid from a nozzle (not illustrated) formed at the discharge head 101 is performed at a timing based on a position signal obtained by the encoder 104. In the present embodiment, an image having a constant bandwidth corresponding to an array range of the nozzle is printed in this manner. The encoder 104 according to the present embodiment is a linear encoder. The linear encoder includes an encoder sensor for reading an encoder scale disposed in the main scanning direction. Thereafter, the printing medium 106 is conveyed and an image corresponding to the next bandwidth is printed.

A carriage belt may be used to transfer drive power from the carriage motor 212 (refer to FIG. 2) to the carriage 102. The printing medium 106 fed is conveyed while being sandwiched between the conveyance roller 211 (refer to FIG. 2) and a pinch roller and is guided to a printing position (scanning region of the discharge head 101) on the platen 107. In a normal stopping state, the carriage 102 moves to a standby position at a right or left end part, and a nozzle surface of the discharge head 101 where the nozzle is formed is capped by a cap (not illustrated).

Thus, at transition from a standby state to printing operation, the cap is opened before printing so that the discharge head 101 and the carriage 102 can be subjected to scanning. Thereafter, data for one scanning is accumulated in a memory 204 (refer to FIG. 2), and then the carriage 102 is subjected to scanning by the carriage motor 212 to perform printing on the printing medium 106. The liquid discharge apparatus 100 includes a non-illustrated dry unit configured to dry the printing medium 106 for fixing ink. The dry unit has a configuration with which, for example, the printing medium 106 is dried with air or the printing medium 106 passes on a heated plate. The dry unit is disposed at a position where the printing medium 106 can be dried while printing is performed and after printing is ended.

One discharge head 101 capable of discharging liquid of one kind or a plurality of discharge heads 101 capable of discharging liquid of different kinds may be mounted on the carriage 102. Alternatively, one discharge head 101 capable of discharging liquid of a plurality of kinds may be mounted on the carriage 102.

One discharge head 101 capable of discharging ink of black (Bk), cyan (Cy), magenta (Ma), and yellow (Ye) is mounted on the carriage 102 according to the present embodiment. Accordingly, the discharge head 101 according to the present embodiment can discharge liquid of four colors while moving in the X direction. In the present embodiment, a circulation flow path and a circulation unit to be described later move in the X direction together with the discharge head 101. The colors of ink are not limited to these colors. Other exemplary colors of ink include light colors such as light cyan and light magenta. Other exemplary colors of ink include particular colors such as green (Gr), red (R), blue (B), and white (W). In particular, a white pigment is preferably used. For example, titanium oxide is widely used as a coloring material for a white ink because it is low in cost and excellent in characteristics, such as whiteness and concealability, required as a white ink. However, titanium oxide, which is a metal oxide, has a higher specific gravity than the coloring materials used for the inks of other colors. As a result, white ink tends to settle more easily than other inks, causing problems in ejection characteristics. Even in such an ink, the discharge characteristics of the discharge head can be kept good by adopting the structure of the present invention. Other exemplary liquid discharged from the discharge head 101 includes reaction liquid for fixing ink onto the printing medium 106. In the present embodiment, ink of all colors is discharged from one discharge head 101, but ink of the above-described four colors may be discharged from a plurality of discharge heads 101, respectively. For example, in a case where the reaction liquid is discharged, discharge heads 101 for the above-described four colors may be provided separately from a discharge head 101 for the reaction liquid. Ink according to the present embodiment contains a pigment and fine particles of resin (resin particles, water-dispersible resin), which are dispersed in water and a volatile organic solvent. As the resin particles contained in ink provided on the printing medium 106 is dried by heating, a plurality of the resin melt and connect to form a film. Accordingly, the ink film formed on the printing medium 106 develops improvement of force of binding to the printing medium 106 and robustness of the ink film. A non-volatile solvent, a surfactant, a pH adjuster, an antiseptic agent, and the like may be added to the above-described ink as appropriate to obtain a desired characteristic.

### Printing Control System of Liquid Discharge Apparatus 100

FIG. 2 is a block diagram illustrating an exemplary configuration of a printing control system of the liquid discharge apparatus 100.

As illustrated in FIG. 2, the liquid discharge apparatus 100 is connected to a data supply apparatus such as a host computer 202 through an interface 201. The liquid discharge apparatus 100 includes the printing control unit 203 for controlling printing operation. Various kinds of data, control signals related to printing, and the like transmitted from the host computer 202 are input to the printing control unit 203.

The printing control unit 203 includes the memory 204 for storing input image data, multiple-value gradation data of an intermediate product, a multipath mask, and the like, and a CPU 205 (or ASIC) that is a control calculation apparatus. In a case where the memory 204 is, for example, a RAM and a ROM, the CPU 205 reads a control program stored in the ROM and executes various kinds of processing, thereby controlling operation of the liquid discharge apparatus 100. The RAM is used as a temporary storage region of the CPU 205, such as a main memory or a work area.

The printing control unit 203 controls a first motor driver 206, a second motor driver 207, a third motor driver 208, and a head driver 209 in accordance with control signals input through the interface 201. The printing control unit 203 performs processing of input image data and processing of signals input from a head type signal generation circuit (not illustrated).

A conveyance motor 210 is a motor capable of performing rotational drive of the conveyance roller 211 for conveys a printing medium. The carriage motor 212 is a motor for performing reciprocate movement of the carriage 102. A recovery mechanism motor 213 is a motor mounted on a recovery mechanism 214 for recovering a discharge state of the discharge head. The recovery mechanism motor 213 switches a driven member through a cam mechanism including a cam shaft and disposed in the recovery mechanism 214. For example, operation of a cap (not illustrated), a wiper guide (not illustrated), or a suction pump (not illustrated) included in the recovery mechanism 214 is switched.

The first motor driver 206, the second motor driver 207, and the third motor driver 208 are drivers for rotational drive of the conveyance motor 210, the carriage motor 212, and the recovery mechanism motor 213, respectively. The head driver 209 is a driver for driving the discharge head 101. For example, the head driver 209 drives an energy generation element 215 disposed inside the discharge head 101. When driven, the energy generation element 215 provides energy to liquid so that liquid can be discharged from the nozzle (not illustrated).

The discharge head 101 in the present embodiment includes a circulation pump 216 for circulating liquid inside the discharge head 101. In the present embodiment, ink of the four colors of black, cyan, magenta, and yellow is circulated by one circulation pump 216. However, a switching cam or the like may be used to switch a case where only black ink is circulated by the one circulation pump 216 and a case where ink of all four colors is circulated by one circulation pump 216. In a case where a plurality of discharge heads 101 are mounted on the carriage 102, a plurality of circulation pumps 216 are disposed in accordance with the number of discharge heads 101. A plurality of circulation pumps 216 may be mounted on one discharge head 101.

A temperature sensor 217 capable of sensing temperature in the surrounding environment of the discharge head 101, and a humidity sensor 218 capable of sensing humidity in the surrounding environment may be disposed in the liquid discharge apparatus 100. The temperature sensed by the temperature sensor 217 and the humidity sensed by the humidity sensor 218 are stored in the memory 204. Although not illustrated, a temperature sensor capable of sensing temperature in the surrounding environment in the vicinity of the nozzle, and a humidity sensor capable of sensing humidity in the surrounding environment in the vicinity of the nozzle may be disposed.

The liquid discharge apparatus 100 includes an anomaly detection unit for detecting anomaly having occurred in printing operation performed by the discharge head 101 (in other words, liquid discharge operation performed by the discharge head). The anomaly detection unit is a well-known liquid remaining amount sensor 220 capable of detecting the remaining amount of liquid in a liquid tank 219, a well-known sheet remaining amount sensor 221 capable of detecting the remaining amount of printing media, and a well-known paper jam sensor 222 capable of detecting a jam of a printing medium.

### Discharge Head 101

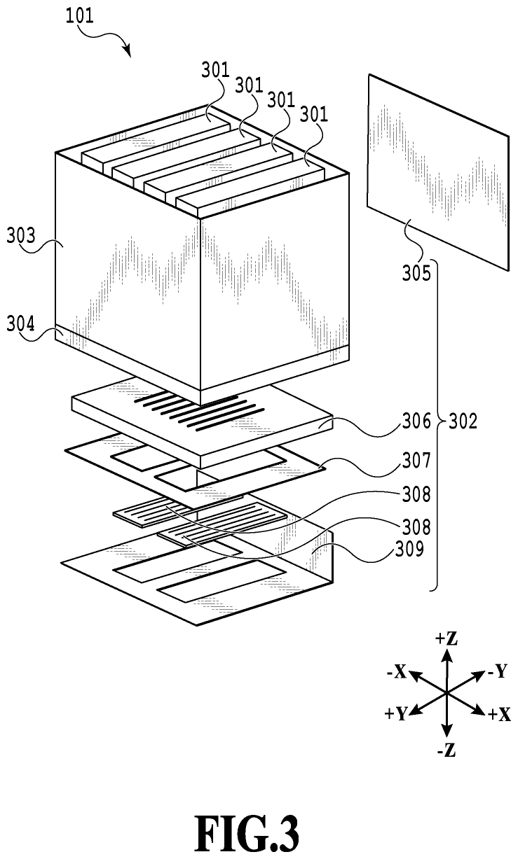

FIG. 3 is an exploded perspective view of the discharge head 101 in the present embodiment. FIG. 3 illustrates an example of the discharge head 101 capable of discharging four kinds of liquid.

As illustrated in FIG. 3, the discharge head 101 includes four circulation mechanisms 301, and a printing element mechanism 302 for receiving liquid supplied from the circulation mechanisms 301 and discharging the liquid to a printing medium.

The circulation mechanisms 301 are housed in a housing 303. A joint member 304 to which the printing element mechanism 302 can be fixed by bonding is fixed by bonding to a bottom surface part of the housing 303. Liquid connector insertion ports (not illustrated) corresponding to four supply tubes are disposed on the back surface side (negative Y direction side) of the four circulation mechanisms 301, respectively, and supply flow paths are individually formed for the respective ports.

The printing element mechanism 302 includes an electric contact substrate 305, a first support member 306, a second support member 307, two discharge modules 308, and an electric wiring member 309 (for example, an electric wiring tape).

Each discharge module 308 includes a silicon-containing substrate (hereinafter referred to as a silicon substrate) and an energy generation element disposed on one surface of the silicon substrate and configured to generate energy to be used to discharge liquid.

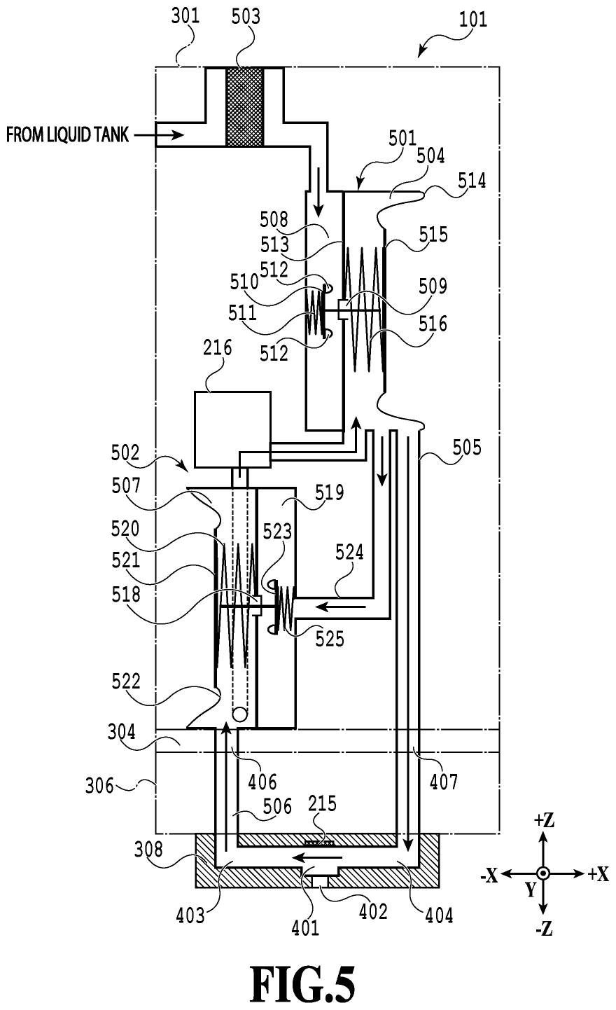

In the present embodiment, the energy generation element is a plurality of heat generation resistance elements (heaters), and an electric wire that supplies electric power to each heat generation resistance element is formed on the silicon substrate by a deposition technology. The energy generation element may be any other component than a heater and may be, for example, a piezo element. A plurality of liquid flow paths corresponding to the heat generation resistance elements, and a pressure chamber 401 (refer to FIG. 5) at which a plurality of nozzles 402 (refer to FIG. 5) for discharging liquid are formed are formed on the silicon substrate by a photolithography technique. Supply ports for supplying liquid to the plurality of liquid flow paths and collection ports for collecting liquid are opened at an upper surface (surface facing in the positive Z direction) of the silicon substrate.

Each discharge module 308 is fixed by bonding to the first support member 306 through which liquid supply ports and liquid collection ports are formed. The second support member 307 through which openings are formed is fixed by bonding to the first support member 306. The second support member 307 holds the electric wiring member 309 such that the electric wiring member 309 is electrically connected to each discharge module 308. The electric wiring member 309 transfers, to each discharge module 308, an electric signal for discharging liquid. In FIG. 3, the circulation mechanisms 301 are illustrated in a visually recognizable manner for the purpose of description. However in reality, the circulation mechanisms 301 are housed inside the housing 303.

Array of nozzle columns formed in each discharge module 308 is not particularly limited. The number of circulation mechanisms 301 disposed in one discharge head 101 may be any other number than four. In addition, arrangement of a plurality of circulation mechanisms 301 is not particularly limited.

### Configuration of Flow Paths

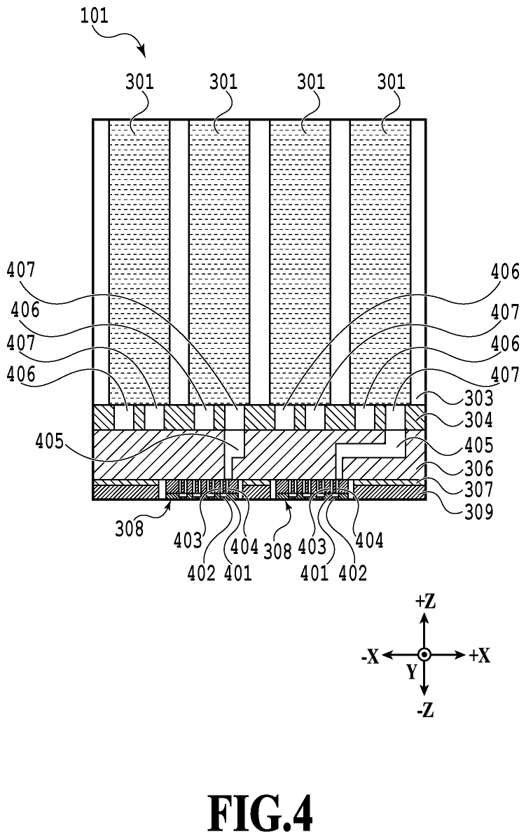

FIG. 4 is a diagram illustrating an exemplary configuration of flow paths in the present embodiment.

As illustrated in FIG. 4, the pressure chamber 401 that can be filled with liquid and a nozzle 402 for discharging liquid are formed in each discharge module 308. In addition, an individual supply flow path 404 for supplying liquid to the pressure chamber 401, and an individual collection flow path 403 for collecting liquid not discharged from the nozzle 402 are formed.

Through a pitch conversion flow path 405 formed in the first support member 306, the widths of the individual supply flow path 404 and the individual collection flow path 403 are increased to the width of an opening formed through the joint member 304. The pitch conversion flow path 405 is connected to and communicates with the various circulation mechanisms 301 through the joint member 304.

The electric wiring member 309 is supported by the second support member 307 and electrically connected to the discharge modules 308. Various supply ports 407 and collection ports 406 are formed through the joint member 304 and connected to the circulation mechanisms 301 to perform liquid supply and collection.

### Circulation Flow Path

FIG. 5 is a schematic diagram illustrating an example of the circulation flow path in the present embodiment. FIG. 5 illustrates a circulation flow path configuration and a pressure adjustment mechanism for one kind of liquid inside the discharge head 101. Each arrow in the flow path represents the direction in which liquid flows.

In FIG. 5, all flow paths for supplying liquid from a first liquid chamber 504 to the pressure chamber 401 are collectively referred to as a supply flow path 505 for the purpose of description. The shape of the supply flow path 505 is simplified in the illustration. All flow paths for collecting liquid from the pressure chamber 401 to the first liquid chamber 504 are collectively referred to as a collection flow path 506. The shape of the collection flow path 506 is simplified in the illustration.

As illustrated in FIG. 5, the discharge head 101 in the present embodiment includes the energy generation element 215 for generating energy for discharging, from the nozzle 402, liquid with which the pressure chamber 401 is filled. For example, the energy generation element 215 is disposed in the discharge module 308. The discharge module 308 can discharge, from the nozzle 402, liquid with which the pressure chamber 401 is filled, thereby printing an image.

The circulation flow path in the present embodiment includes the pressure chamber 401 and is formed to circulate liquid between a first pressure adjustment mechanism 501 and a second pressure adjustment mechanism 502. When liquid is to be circulated, the circulation pump 216 disposed between the first pressure adjustment mechanism 501 and the second pressure adjustment mechanism 502 is driven. The circulation pump 216 can generate pressure with which liquid can be circulated through the circulation flow path.

Liquid supplied from the liquid tank through a supply tube is pressurized by a pressurization pump (not illustrated) disposed in a liquid discharge apparatus body. The pressurized liquid passes through a filter 503 at positive pressure and is depressurized to a predetermined pressure through a first valve chamber 508 and supplied to the first liquid chamber 504 disposed as a first pressure control chamber. The depressurized liquid is supplied from the first liquid chamber 504 to the pressure chamber 401 through the supply flow path 505.

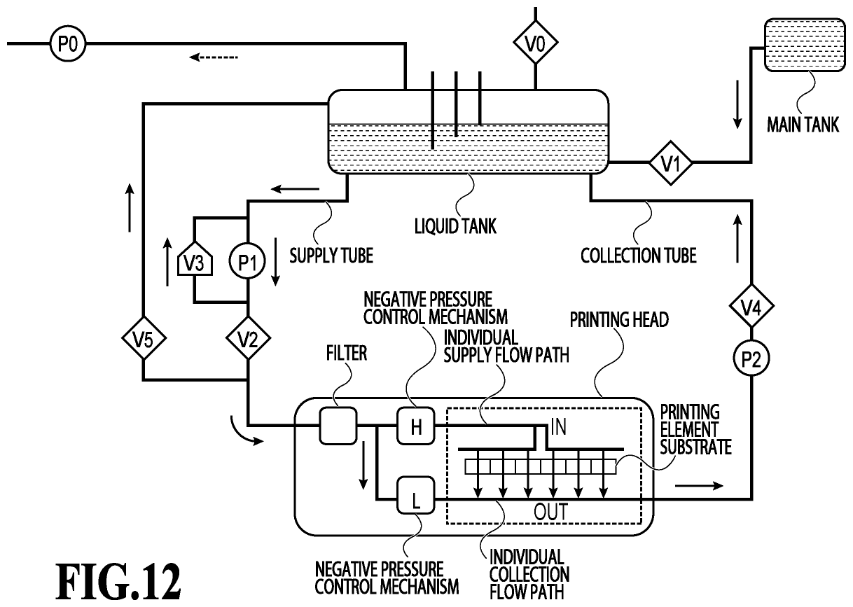

Liquid not discharged from the nozzle 402 formed to communicate with the pressure chamber 401 is supplied to a second liquid chamber 507 through the collection flow path 506. The circulation pump 216 communicating with the second liquid chamber 507 is disposed downstream of the second liquid chamber 507 (above the second liquid chamber 507 in FIG. 5). Liquid supplied from the second liquid chamber 507 to the circulation pump 216 can be collected to the first liquid chamber 504 as the circulation pump 216 is driven. In this manner, the circulation flow path can be completed inside the discharge head 101 in the present embodiment. The form of the circulation flow path is not limited thereto but may be the form of circulation through a flow path including the outside of the discharge head 101. For example, the form may be of circulation as in FIG. 12 in which ink enters a discharge head (provided in a printing element substrate in FIG. 12) from a liquid tank through a supply tube, leaves the discharge head through a pressure chamber, and returns to the liquid tank. Although ink returns to the liquid tank in the circulation in FIG. 12, ink leaving the discharge head 101 may pass through the supply tube but not the liquid tank in circulation.

The first pressure adjustment mechanism 501 includes the first valve chamber 508, and the first liquid chamber 504 communicating with the first valve chamber 508 through a first communication port 509. A first valve 510 with which the first communication port 509 is switchable between an opened state and a closed state is disposed in the first valve chamber 508.

The first valve 510 is pressed by a first valve spring 511 in a direction (the positive X direction in the drawing) in which the first communication port 509 is closed. For example, an elastic member 512 is included in part of the first valve 510. The first communication port 509 is closed as the elastic member 512 is pressed by the first valve spring 511 against a first wall portion 513 partitioning the first liquid chamber 504 and the first valve chamber 508.

The first liquid chamber 504 includes a first flexible member 514 partially opened and a first pressure plate 515 that blocks the opening. The first pressure plate 515 can be displaced along with displacement of the first flexible member 514. The first pressure plate 515 is, for example, a resin molded component. The first flexible member 514 is, for example, a resin film.

The first liquid chamber 504 is formed by fixing (for example, thermal welding) the first pressure plate 515 to the first flexible member 514. The first flexible member 514 and the first pressure plate 515 are pressed by a first pressure adjustment spring 516 in a direction (the positive X direction in the drawing) in which the internal capacity of the first liquid chamber 504 is increased. As the pressure of the first liquid chamber 504 decreases (negative pressure increases), the first pressure plate 515 and the first flexible member 514 is displaced in a direction (the negative X direction in the drawing) in which the internal capacity is decreased. Then, when the pressure in the first liquid chamber 504 decreases to a predetermined value or smaller and the amount of displacement of the first flexible member 514 exceeds a predetermined displacement amount, the first pressure plate 515 contacts the first valve 510. In the present embodiment, the first valve 510 includes a contact member extending in the positive X direction substantially from the center. The contact member extends through the first communication port 509 such that the contact member can contact the first pressure plate 515 as the first pressure adjustment spring 516 deforms.

A second valve 523 to be described later includes a contact member extending in the negative X direction substantially from the center of the second valve 523. The contact member extends through a second communication port 518 such that the contact member can contact a second pressure plate 521 as a second pressure adjustment spring 520 deforms.

Thereafter, as the first pressure plate 515 presses the contact member of the first valve 510, the first valve 510 is displaced in a direction (the negative X direction in the drawing) in which the first communication port 509 is opened. The pressure of the first valve chamber 508 when opened is set to be higher than the pressure of the first liquid chamber 504 so that liquid flows from the first valve chamber 508 into the first liquid chamber 504.

The first flexible member 514 and the first pressure plate 515 are displaced in the direction in which the internal capacity of the first liquid chamber 504 increased since the pressure increases as liquid flows in. As a result, the first pressure plate 515 is separated from the first valve 510, and accordingly, the first valve 510 blocks and closes the first communication port 509. Thereafter, as the pressure in the first liquid chamber 504 becomes equal to or smaller than the predetermined value again, liquid flows from the first valve chamber 508 into the first liquid chamber 504 through the first communication port 509.

In this manner, the first liquid chamber 504 prevents the pressure in the first liquid chamber 504 from becoming smaller than the predetermined value. In other words, in the present embodiment, the pressure in the first liquid chamber 504 is controlled to be in a predetermined range.

The configuration of the second pressure adjustment mechanism 502 is substantially the same as the configuration of the first pressure adjustment mechanism 501. The second pressure adjustment mechanism 502 includes the second liquid chamber 507 disposed as a second pressure control chamber, and a second valve chamber 519 that communicating with the second liquid chamber 507 through the second communication port 518. As the circulation pump 216 is driven, liquid flows from the second liquid chamber 507 into the circulation pump 216. Then, the liquid is collected from the circulation pump 216 to the first liquid chamber 504.

Simultaneously, the pressure in the second liquid chamber 507 decreases. Accordingly, the second pressure plate 521 and a second flexible member 522 being pressed by the second pressure adjustment spring 520 are displaced in a direction (the positive X direction in the drawing) in which the internal capacity of the second liquid chamber 507 is decreased. Then, the second pressure plate 521 contacts the contact member of the second valve 523 and presses the second valve 523. In this manner, the second pressure plate 521 displaces the second valve 523 in a direction (the positive X direction in the drawing) in which the second communication port 518 is opened.

The following describes a case where liquid inflow stops.

Pressure difference occurs between the first liquid chamber 504 and the second liquid chamber 507 along with liquid movement by the circulation pump 216. With the pressure difference, liquid flows from the first liquid chamber 504, in which pressure is higher than in the second liquid chamber 507, into the second liquid chamber 507 through a flow path 524, the second valve chamber 519, and the second communication port 518.

In the state in which liquid flows into the second liquid chamber 507, a second valve spring 525 presses the second valve 523 in a direction (the negative X direction in the drawing) in which the second communication port 518 is closed. In addition, the second pressure adjustment spring 520 presses the second pressure plate 521 in a direction (the negative X direction in the drawing) in which the internal capacity of the second liquid chamber 507 is increased. In this manner, the second valve 523 is displaced in a direction in which the second valve 523 is closed as liquid in an amount exceeding the amount of liquid movement by the circulation pump 216 flows from the second valve chamber 519 into the second liquid chamber 507 through the second communication port 518.

As the second valve 523 is displaced in the closing direction, the second communication port 518 is blocked and liquid inflow stops.

The case where liquid inflow stops is described above.

The pressure of the second liquid chamber 507 is maintained in a constant negative pressure state while the circulation pump 216 is driven. In the present embodiment, while the circulation pump 216 is driven, the strengths of the second pressure adjustment spring 520 and the second valve spring 525 are adjusted so that pressure is lower in the second liquid chamber 507 than in the first liquid chamber 504. Similarly, the strengths of the first valve spring 511 and the first pressure adjustment spring 516 are adjusted as well.

With the above-described configuration, pressure difference occurs between the first liquid chamber 504 and the second liquid chamber 507 as the circulation pump 216 is driven. As a result, such flow is generated that liquid circulates between the first liquid chamber 504 and the second liquid chamber 507 through the pressure chamber 401 formed in the discharge module 308.

As described above, liquid moves at a certain flow speed near the nozzle 402 as the circulation pump 216 is driven. Accordingly, it is possible to reduce viscosity increase and agglomeration of a solid content such as a pigment, which occur through evaporation of liquid in the nozzle 402. Moreover, it is also possible to reduce discharge characteristic decrease due to viscosity increase through liquid evaporation by driving the circulation pump 216 during printing operation. In the present embodiment, in a state in which the cap is opened, continuous circulation instead of intermittent circulation is performed to reduce viscosity increase. Accordingly, liquid continuously circulates during printing operation.

### Recovery Mechanism 214

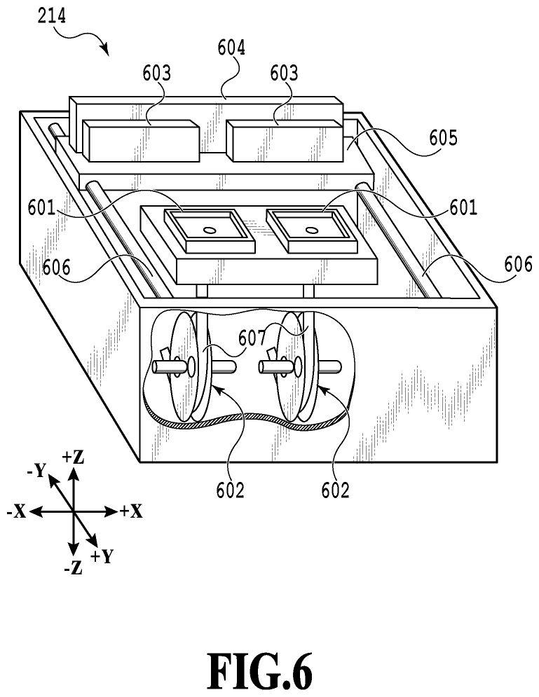

FIG. 6 is a diagram for description of the configuration of the recovery mechanism 214 in the present embodiment.

As illustrated in FIG. 6, the recovery mechanism 214 includes caps 601 capable of capping the nozzle surface where the nozzle is formed, and suction pumps 602 for sucking liquid from the discharge head in a state in which the nozzle surface is capped. The recovery mechanism 214 includes first wipers 603 and a second wiper 604 for wiping the nozzle surface, a wiper holder 605 fixing these wipers, and guide portions 606 for guiding movement of the wiper holder 605.

The above-described carriage stops at the standby position outside a printing region as necessary before a time point at which printing operation is started and during the printing operation. The recovery mechanism 214 is disposed at a position facing the discharge head stopping at a standby position. Typically, the recovery mechanism 214 is disposed outside the printing region in the moving direction of the carriage.

The caps 601 are supported to be movable upward and downward (movable in the Z direction in the drawing) by a movement mechanism (not illustrated). Accordingly, the caps 601 can move between a moved-up position and a moved-down position. At the moved-up position, the caps 601 contact the discharge head and caps the nozzle surface. The caps 601 form a substantially sealed space by capping the nozzle surface.

Since the caps 601 form the substantially sealed space, it is possible to reduce nozzle drying and liquid evaporation during non-printing operation. Moreover, it is possible to suck liquid from the discharge head by driving the suction pumps 602 in a state in which the caps 601 cap the nozzle surface of the discharge head.

### Auxiliary Discharge

During printing operation, the caps 601 are each positioned at the moved-down position to avoid interference with the discharge head moving together with the carriage. The discharge head can perform auxiliary discharge to the caps 601 after the discharge head moves to a position facing the caps 601 in a state in which the caps 601 are positioned at the moved-down position.

### Wiping Operation

The first wipers 603 and the second wiper 604 are elastic members such as rubber. In the present embodiment, the two first wipers 603 can wipe the nozzle surface at two discharge modules 308 (refer to FIG. 3). The second wiper 604 can wipe the nozzle surface at the two discharge modules 308 (refer to FIG. 3).

The first wipers 603 and the second wiper 604 are fixed to the wiper holder 605. The wiper holder 605 is movable along the guide portions 606 in the positive Y direction and the negative Y direction (array direction of the nozzle of the discharge head) in FIG. 6.

The first wipers 603 and the second wiper 604 can be moved in contact with the nozzle surface by moving the wiper holder 605 in one direction (the positive Y direction in the drawing) while the discharge head is stopping at the standby position. Accordingly, wiping operation that wipes the nozzle surface can be performed by moving the wiper holder 605 in the one direction (the positive Y direction in the drawing) while the discharge head is stopping at the standby position.

First after wiping operation ends, the CPU 205 (refer to FIG. 2) retracts the carriage from a region in which the wiping operation is performed. Subsequently, the CPU 205 moves the wiper holder 605 and returns the first wipers 603 and the second wiper 604 to their original positions (positions before the wiping operation).

### Suction Operation

The suction pumps 602 are driven while the space formed by capping the nozzle surface is substantially sealed. Suction operation that sucks liquid from the discharge head is performed by generating negative pressure inside the space. The suction operation is performed in a case (initial filling) of filling the discharge head with liquid from the liquid tank or in a case (suction recovery) of removing dust, fixations, air bubbles, and the like inside the nozzle by suction. The caps 601 are connected to a waste liquid absorber (not illustrated) through flexible tubes 607.

In the present embodiment, tube pumps is used as the suction pumps 602. Each tube pump includes a holding portion including a curved surface part along which the corresponding tube 607 (at least part thereof) is fitted and held, a roller (not illustrated) capable of pressing the held tube 607, and a roller support part (not illustrated) rotatably supporting the roller. The tube pump rotates the roller support part in a predetermined direction, thereby rotating the roller while pressing the tube 607 flat. Accordingly, negative pressure is generated inside each cap 601, and liquid is sucked from the discharge head. The sucked liquid is discharged to the waste liquid absorber through each tube 607.

In a case where auxiliary discharge to the caps 601 is performed by the discharge head, suction operation is performed to discharge liquid received by the caps 601 through the auxiliary discharge. In a case where auxiliary discharge is performed by the discharge head, liquid discharged by the auxiliary discharge is received by the caps 601. Suction operation is performed to discharge the liquid received by the caps 601. Specifically, in a case where liquid subjected to auxiliary discharge and held in the caps 601 reaches a predetermined amount, the suction pumps 602 are driven to discharge the liquid held in the caps 601 to the waste liquid absorber (not illustrated) through the tubes 607.

### Case Where Anomaly Has Occurred

Normally, the nozzle is prevented from drying since the nozzle surface is capped at transition from a state in which printing operation is performed to the standby state. In other words, as long as no anomaly occurs to the liquid discharge apparatus body, the nozzle can be prevented from drying by capping the nozzle surface in a state in which printing operation is not performed. Ink circulation may be stopped while the nozzle surface is capped. Ink may be periodically circulated while the nozzle surface is capped. For example, circulation of white ink, which is likely to sink, may be periodically performed to agitate white ink while the nozzle surface for white ink is capped. Circulation of white ink may be periodically performed during sleep. Ink circulation may be periodically performed for, for example, ink temperature adjustment and deaeration. For example, circulation of all kinds of liquid may be performed at least once a day.

However, in a case where anomaly has occurred to the liquid discharge apparatus body, the liquid discharge apparatus needs to be set to standby in a state in which the nozzle surface cannot be capped, depending on the kind of the anomaly. In other words, in a case where anomaly has occurred to the liquid discharge apparatus body, the liquid discharge apparatus cannot be set to standby in a normal standby state, depending on the kind of the anomaly.

A state in which the liquid discharge apparatus cannot be set to standby in the normal standby state is a state in which the nozzle surface cannot be capped for standby due to anomaly having occurred to the liquid discharge apparatus. In such a case, the liquid discharge apparatus according to the present embodiment reduces evaporation of liquid in the nozzle by driving the circulation pump.

The following describes control performed in a case where anomaly has occurred to the liquid discharge apparatus body in the present embodiment. An example of the state in which the liquid discharge apparatus cannot be set to standby in the normal standby state is a case where the carriage collides with a printing medium and causes a paper jam while moving and the carriage cannot be returned to the standby position. Another example is a case where the carriage is at the standby position but the caps 601 cannot be moved to the moved-up position where the caps 601 contact the discharge head by using the movement mechanism.

Whether the carriage is returned to the standby position is determined by, for example, a method of obtaining the current position of the discharge head based on the moving amount of the carriage, which is detected by an encoder. Whether the caps 601 are moved to the moved-up position may be determined by, for example, a method of obtaining the positions of the caps 601 by detecting whether the movement mechanism is operated based on the rotation angle and moving amount of the cam mechanism configured to move the caps 601.

It can be determined that the nozzle surface is capped in a case where it is confirmed that the carriage is at the standby position and the caps 601 are at the moved-up position. In other words, in a case where at least one of these positions cannot be confirmed, it can be determined that the discharge head cannot be set to the normal standby state. In the present embodiment, the caps 601 are moved up and down, but the discharge head 101 may be moved up and down to cap the nozzle surface. In this case, whether the nozzle surface is capped can be determined by detecting not the positions of the caps 601 but the position of a movement mechanism configured to move up and down the discharge head 101.

### Water Evaporation Near Nozzle

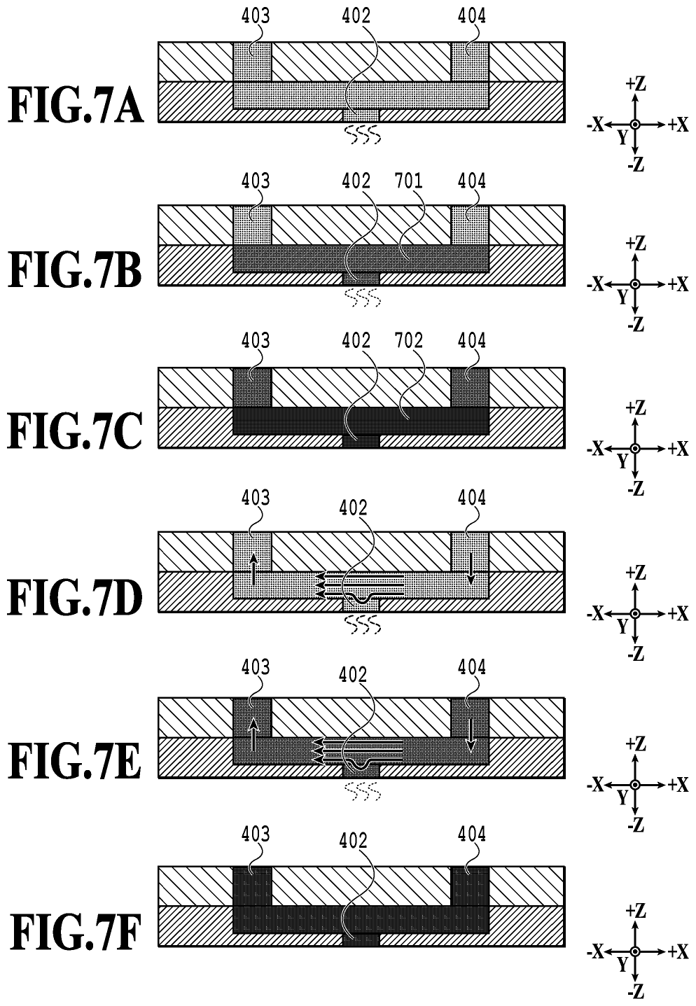

FIGS. 7A to 7F are diagrams schematically illustrating a situation in which water evaporates in the vicinity of the nozzle 402 in a state in which the nozzle is not capped. The density of hatching of a flow path illustrated in FIGS. 7A to 7F represents the condensation state of liquid. The density of dotted lines extending from the nozzle 402 represents the degree of water evaporation. Arrows illustrated in FIGS. 7D and 7E represent the direction of liquid flow.

As illustrated in FIG. 7A, water gradually evaporates from the nozzle 402 into air in a state in which the circulation pump stops and liquid in the vicinity of the nozzle does not move. As the water evaporation continues for a long time, a state illustrated in FIG. 7B is reached.

As illustrated in FIG. 7B, water is partially lost in the vicinity of the nozzle. In this state, the viscosity of liquid gradually increases and the flowability of liquid decreases (refer to a region 701). The amount of water evaporation decreases as compared to FIG. 7A. As water further evaporates, a state illustrated in FIG. 7C is reached.

As illustrated in FIG. 7C, in a state in which water has evaporated as compared to the state illustrated in FIG. 7B, water evaporates also in the individual supply flow path 404 and the individual collection flow path 403, and the vicinity of the nozzle is filled with agglomerated solid contents along with water evaporation (refer to a region 702). Once this state is reached, the nozzle 402 and the inside of the flow paths are partially or entirely blocked by agglomeration of solid contents or filled with liquid of high viscosity, and accordingly, flowability is lost. In this state, water hardly evaporates from the nozzle 402.

In such a state, it is difficult to discharge condensed liquid in the flow paths even though execution of recovery operation (that is, suction operation) of generating negative pressure in the nozzle 402 by using the caps and the suction pumps and discharging liquid. In other words, as the state illustrated in FIG. 7C continues, it becomes difficult to restore a state in which liquid can be normally discharged. Thus, in a case where anomaly occurs to the liquid discharge apparatus and the nozzle surface is not capped, liquid further condenses inside the nozzle 402, which potentially leads to agglomeration of solid contents. To prevent such a situation, the circulation pump is driven in the present embodiment to reduce decrease of the ratio of water in the vicinity of the nozzle.

FIG. 7D illustrates liquid flow and an evaporation state in a case where the circulation pump is driven in a state in which the nozzle surface is not capped. As illustrated in FIG. 7D, water evaporates from the nozzle 402 even when the circulation pump is driven in a state in which the nozzle surface is not capped.

However, since liquid flows in the circulation flow path including the circulation mechanisms, the evaporation rate of water in the liquid can be substantially uniformized in a flow path including the individual supply flow path 404 and the individual collection flow path 403. Thus, even if the nozzle surface is not capped, local increase of liquid viscosity can be avoided as long as a time period in which the nozzle surface is not capped is relatively short, and accordingly, the circulation pump can be continuously driven to continue liquid circulation.

However, in a case where the circulation pump is driven for a relatively long time in a state in which the nozzle surface is not capped, the ratio of water in the entire liquid in the circulation flow path gradually decreases as illustrated in FIG. 7E. In other words, the viscosity of liquid in the entire circulation flow path gradually increases as a state in which the nozzle surface is not capped continues for a relatively long time even though the circulation pump is driven. As described above, in the present embodiment, the pressure difference between the first liquid chamber and the second liquid chamber is maintained constant by spring force. Accordingly, the flow speed of liquid flowing inside the circulation flow path decreases as the viscosity of liquid in the circulation flow path increases.

As a state in which the nozzle surface is not capped continues for a further long time, liquid circulation eventually stops as illustrated in FIG. 7F. This is because, as the ratio of water in the entire liquid in the circulation flow path largely decreases, the viscosity of liquid becomes too high and a pressure loss in the circulation flow path becomes larger than the pressure difference between the liquid chambers when liquid is circulated. In this manner, liquid is firmly fixed as a state in which the nozzle surface is not capped continues for a relatively long time even though the circulation pump is continuously driven.

However, even if liquid is firmly fixed, a time period until solid content agglomeration or fixation becomes problem since a time point at which anomaly occurs is longer in a case where the circulation pump is driven than in a case where the circulation pump is not driven. This is because the liquid capacity of the entire circulation flow path is sufficiently larger than the liquid capacity of the vicinity of the nozzle. Thus, even in a case where a state in which the nozzle surface is not capped continues for a relatively long time, a time period until a state in which recovery is impossible is reached can be extended by driving the circulation pump as compared to a case where the circulation pump is not driven.

However, even if the liquid discharge apparatus can be returned to a normal state before a time point at which a state in which recovery is impossible is reached, evaporation of liquid in the circulation flow path potentially causes change of the concentration of a printed image and affects formation of a droplet discharged from the nozzle 402. This is because liquid further condenses and the viscosity increases as a state in which the nozzle surface is not capped continues for a relatively long time.

Thus, to achieve a state in which an image can be normally printed, condensed liquid is preferably discharged to regain the original liquid concentration. The above-described auxiliary discharge or suction operation is an example of a specific method of regaining the original liquid concentration.

Intermittent circulation in which circulation and stop are alternately performed is more preferably performed by the circulation pump from the time point of detection of anomaly with which the nozzle surface cannot be capped to the time point of resolution of the anomaly.

With intermittent circulation, the time period from a time point at which anomaly occurs to a time point at which liquid is firmly fixed can be further extended as compared to a case where the circulation pump is continuously driven. Accordingly, although evaporation of water in liquid in the circulation flow path can be reduced by continuously driving the circulation pump, evaporation of water in liquid in the circulation flow path can be further reduced by intermittently driving the circulation pump. Moreover, the amount of liquid discharged by auxiliary discharge can be reduced.

In a state in which intermittent circulation is performed, liquid smoothly flow as illustrated in FIG. 7D as the circulation pump is driven. Then, once the circulation pump stops, water contained in liquid evaporates in the vicinity of the nozzle as illustrated in FIG. 7B.

However, the stop time period of the circulation pump needs be in a range with which liquid in the vicinity of the nozzle can flow by the pressure difference between the first liquid chamber and the second liquid chamber even if the viscosity of liquid increases. As long as the stop time period satisfies this condition, pressure difference is generated between the above-described two liquid chambers by driving the circulation pump again, and accordingly, thickened liquid in the vicinity of the nozzle mixes with non-condensed liquid in the circulation flow path and the concentration of liquid is uniformized. In other words, the state of liquid returns from the state illustrated in FIG. 7B to the state illustrated in FIG. 7D.

The pace of water evaporation in a case where the circulation pump is intermittently driven, including the stop time period of the circulation pump is substantially equivalent to the pace of water evaporation in a case where the circulation pump is continuously driven, including the stop time period of the circulation pump. However, the ratio of water in liquid gradually decreases in the vicinity of the nozzle during stop of the circulation pump in a case where the circulation pump is intermittently driven. Accordingly, the speed of water evaporation from the nozzle in a case where the circulation pump is intermittently driven is lower than the speed of water evaporation from the nozzle in a case where the circulation pump is continuously driven. Thus, in a situation in which intermittent circulation is performed, the concentration of liquid in the circulation flow path is more uniformized as the stop time period of the circulation pump is longer. Accordingly, the pace of water evaporation can be decreased by performing intermittent circulation.

### Transition of Ratio of Water in Liquid in Circulation Flow Path

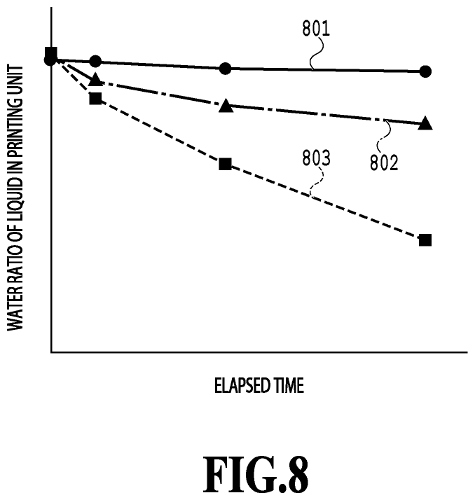

FIG. 8 is a graph illustrating the relation between the ratio of water in liquid in the discharge head and elapsed time. The vertical axis of the graph represents the ratio of water in liquid in the discharge head. The horizontal axis of the graph represents time elapsing in a state in which the nozzle surface is not capped. In other words, the horizontal axis represents time elapsing in a state in which the nozzle surface is exposed to air.

The graph illustrated with a solid line 801 and circular plots represents the ratio of water in a case where the circulation pump is not driven. The graph illustrated with a dashed-dotted line 802 and triangular plots represents the ratio of water in a case where drive and stop of the circulation pump are repeated at a constant frequency. In other words, the graph represents the ratio of water in a case where intermittent circulation is performed. The graph illustrated with a dotted line 803 and rectangular plots represents the ratio of water in a case where the circulation pump is continuously driven.

As indicated by the graph of the solid line 801, the decrease amount of the ratio of water is smallest in a case where the circulation pump is not driven. As water evaporates, a component such as a solvent other than water or a solid content stays in a flow path in the vicinity of the nozzle. Then, water becomes unlikely to evaporate on the upper side of the nozzle (for example, the positive Z direction side in FIGS. 7A to 7F). The amount of liquid in the vicinity of the nozzle is several μL, and the amount of liquid in the discharge head including the individual supply flow path and the individual collection flow path is 10 mL approximately. Accordingly, liquid can be firmly fixed in the vicinity of the nozzle, but the average ratio of water in liquid in the circulation flow path hardly changes.

As indicated by the graph of the dotted line 803, the decrease amount of the ratio of water is largest in a case where the circulation pump is continuously driven. In the vicinity of the nozzle, a certain flow speed occurs as liquid circulates. Accordingly, water evaporates at a meniscus surface of the nozzle, but the ratio of water is averaged as liquid in the vicinity of the nozzle mixes with liquid in the circulation flow path while circulation is performed.

However, the amount of liquid in the circulation flow path is finite although the ratio of water is averaged. Accordingly, the ratio of water in liquid gradually decreases as a time period in which the nozzle surface is exposed to air increases. Furthermore, as the time period in which the nozzle surface is exposed to air increases, a pressure loss increases in the circulation flow path due to liquid thickening. If the pressure loss exceeds the pressure difference between the first liquid chamber and the second liquid chamber, circulation stops, and accordingly, solid contents agglomerate and liquid is firmly fixed in the nozzle.

As indicated by the graph of the dashed-dotted line 802, the ratio of water in a case where intermittent circulation is performed is lower than the ratio of water in a case where circulation is not performed. However, the ratio of water in a case where intermittent circulation is performed is higher than the ratio of water in a case where circulation is continuously performed. Thus, decrease of the ratio of water can be reduced by intermittently driving the circulation pump.

For example, the ratio of the drive time period to the stop time period of the circulation pump is assumed to be 1:10. In this case, as indicated by the graphs, the pace of water evaporation in the entire circulation flow path is ½ approximately of that in a case where the circulation pump is continuously driven due to an effect that the speed of water evaporation decreases during stop of the circulation pump.

However, a time period in which the circulation pump can be stopped is affected by the increase amount of the viscosity of liquid in the vicinity of the nozzle. This is because water evaporates from the nozzle in a case where intermittent circulation is performed, as well.

Thus, in the present embodiment, time period in which the circulation pump is stopped in intermittent circulation is determined based on the temperature and humidity around the discharge head. The time period in which the circulation pump is stopped may be determined based on the composition of liquid, a flow path configuration in the vicinity of the nozzle, the pressure difference between the first and second liquid chambers, a time period in which intermittent circulation is continued in a state in which the nozzle surface is not capped, and the like. Thus, the time period in which the circulation pump is stopped may be determined in the range of the stop time period in which liquid in the vicinity of the nozzle can flow in a case where the circulation pump is driven again.

### Stop Time Period of Circulation Pump

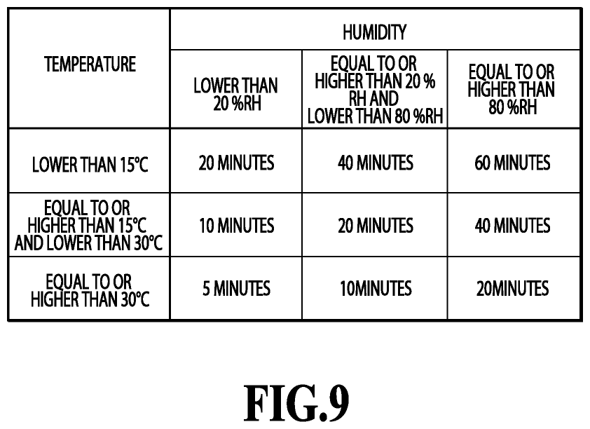

FIG. 9 is a diagram illustrating an example of a table for determining a time period “T2” in which the circulation pump is stopped based on the temperature and humidity around the discharge head. In the present embodiment, a time period “T1” in which the circulation pump is driven is fixed to one minute, and the ratio of the drive time period “T1” and the stop time period “T2” is determined by changing the time period “T2” in which the circulation pump is stopped.

The stop time period “T2” of the circulation pump is determined to be shorter in a higher-temperature and lower-humidity environment in which the speed of water evaporation from the nozzle is faster. In the example illustrated in FIG. 9, the stop time period “T2” of the circulation pump is determined to be five minutes in a case where the temperature around the discharge head is equal to or higher than 30° C. and the humidity is lower than 20% RH.

The stop time period “T2” of the circulation pump is determined to be longer in a lower-temperature and higher-humidity environment in which the speed of water evaporation from the nozzle is slower. In the example illustrated in FIG. 9, the stop time period “T2” of the circulation pump is determined to be 60 minutes in a case where the temperature around the discharge head is lower than 15° C. and the humidity is equal to or higher than 80% RH.

Since the stop time period “T2” is determined based on the temperature and humidity around the discharge head, the evaporation rate of water contained in liquid in the vicinity of the nozzle can be set in the range of viscosity with which liquid can flow under the pressure difference between the first liquid chamber and the second liquid chamber.

The temperature in the vicinity of the nozzle is high in some cases, for example, right after printing operation is stopped. Accordingly, the temperature around the discharge head, which is obtained by a temperature sensor is largely deviated from the temperature in the vicinity of the nozzle in some cases.

The speed of water evaporation from the nozzle is fast in a case where the temperature in the vicinity of the nozzle is high. Thus, in a case where the temperature around the discharge head is potentially largely deviated from the temperature in the vicinity of the nozzle, a temperature sensor for sensing the temperature in the vicinity of the nozzle may be prepared and the stop time period “T2” may be determined based on the temperature in the vicinity of the nozzle. Thus, the discharge head may include a temperature sensor for sensing the temperature in the vicinity of the nozzle in addition to a temperature sensor for sensing the temperature around the discharge head.

For example, in a case where the temperature around the discharge head is lower than 30° C. but the temperature in the vicinity of the nozzle is equal to or higher than 40° C., the stop time period “T2” may be selected from the row of “higher than 30° C.” illustrated in FIG. 9. Thus, correction in a table referred in a case where the temperature around the discharge head is deviated from the temperature in the vicinity of the nozzle may be determined with taken into account the speed of temperature decrease in non-printing operation.

The drive time period “T1” of the circulation pump may be set to be the drive time period “T1” that is sufficient for thickened liquid in the vicinity of the nozzle to mix with liquid in the circulation flow path after pressure difference occurs.

Moreover, as for the discharge head on which a plurality of circulation units can be mounted as in the present embodiment, the drive time period “T1” and the stop time period “T2” may be changed depending on the kind of liquid.

### Control Process in Case Where Anomaly Has Occurred

Examples of anomaly that can occur to the liquid discharge apparatus include anomaly with which it is possible to move the discharge head to the standby position in a case where the anomaly has occurred, and anomaly with which it is difficult to move the discharge head to the standby position in a case where the anomaly has occurred.

Examples of anomaly with which it is possible to move the discharge head to the standby position include runout of the remaining amount of liquid. Another example is runout of the remaining amount of printing media. In such a case, movement of the carriage is not encumbered despite the occurrence of anomaly. Accordingly, in a case where such anomaly is detected, the CPU 205 (refer to FIG. 2) drives the carriage motor and moves the carriage to the standby position. Then, printing operation is stopped after the nozzle surface is capped.

Examples of anomaly with which it is difficult to move the discharge head to the standby position include collision of the carriage with a printing medium. One of typical examples of collision of the carriage with a printing medium is a paper jam.

For example, in a case where a paper jam has occurred, the moving amount of the carriage, which is detected by the encoder is different from a moving amount estimated from the drive amount of the carriage motor. In a case where the moving amount of the carriage, which is detected by the encoder is different from the moving amount estimated from the drive amount of the carriage motor, the CPU 205 determines that it is difficult to normally move the carriage. Then, the CPU 205 stops the carriage at the current position. This is because the discharge head contacts a printing medium and is potentially damaged in a case where the carriage is moved again despite anomaly detection during movement of the carriage. The CPU 205 moves the carriage to the standby position in a case where an operator of the liquid discharge apparatus removes a printing medium caught by the carriage and then instructs restoration of the apparatus or reactivates the apparatus. Then, the nozzle surface is capped at the standby position.

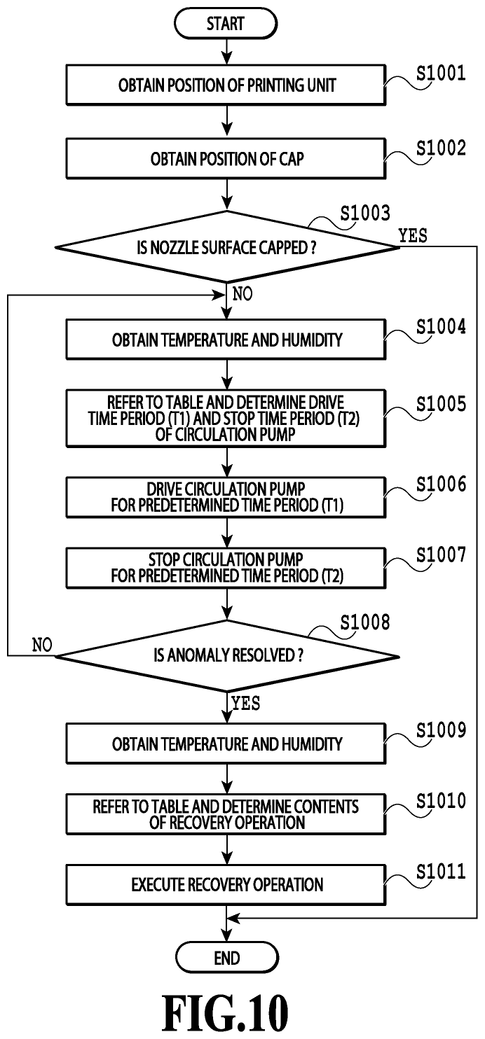

FIG. 10 is a flowchart illustrating the procedure of control executed in a case where anomaly has occurred to the liquid discharge apparatus. The symbol “S” in description of a control process indicates a step. For example, the CPU 205 (refer to FIG. 2) executes a series of processes illustrated in FIG. 10 by executing a computer program stored in a ROM by using a RAM as a work memory. Not all processes described below need to be executed by the CPU 205. The liquid discharge apparatus may be configured such that some or all of the processes below are performed by one or a plurality of processing circuits other than the CPU 205.

At S1001, the CPU 205 obtains information including the position of the discharge head in the X direction based on a detection result of an encoder scale read by the encoder sensor. Having obtained the information including the position of the discharge head, the CPU 205 executes a process at S1002.

At S1002, the CPU 205 obtains information including the position of the cap in the Z direction based on information including the amount of operation of the cam mechanism configured to move up and down the cap and a rotation direction.

At S1003, the CPU 205 determines whether the nozzle surface is capped by the cap based on the position information of the discharge head in the X direction and the information related to operation of the cam mechanism for moving up and down the cap. In a case where the discharge head is positioned at the standby position and the cap is positioned at the moved-up position, it is determined that the nozzle surface is capped. In a case where the nozzle surface of the discharge head is capped (YES at S1003), the CPU 205 ends the present procedure. This is because, in a case where the nozzle surface is capped, water evaporation is reduced and stop of the circulation pump causes no problem. In this manner, liquid circulation is not performed in a case where the capped state is determined at S1003. In a case where ink circulation performed by the circulation pump 216 during printing is not stopped, drive of the circulation pump 216 is stopped. Thereafter, liquid circulation is performed in the capped state in a case where periodic circulation is performed.

In a case where the discharge head is positioned at the printing region (that is, a position other than the standby position) or the cap is positioned at the moved-down position, it is determined that the nozzle surface is not capped. In a case where the nozzle surface formed at the discharge head is not capped (NO at S1003), the CPU 205 executes a process at S1004.

At S1004, the CPU 205 obtains the temperature around the discharge head, which is sensed by a temperature sensor and the humidity around the discharge head, which is sensed by a humidity sensor. Having obtained the temperature and humidity around the discharge head, the CPU 205 executes a process at S1005.

At S1005, the CPU 205 refers to the table in FIG. 9 and determines the drive time period “T1” and the stop time period “T2” of the circulation pump based on the temperature and humidity around the discharge head. Having determined the drive time period and stop time period of the circulation pump, the CPU 205 executes a process at S1006.

At S1006, the CPU 205 drives the circulation pump for a predetermined time period (“T1”). In the present embodiment, the CPU 205 drives the circulation pump for one minute. Having driven the circulation pump for the predetermined time period, the CPU 205 executes a process at S1007.

At S1007, the CPU 205 stops the circulation pump for a predetermined time period (“T2”). The stop time period “T2” of the circulation pump is determined based on the temperature and humidity around the discharge head as described above with reference to FIG. 9. Alternatively, the stop time period “T2” of the circulation pump may be determined based on the temperature and humidity in the vicinity of the nozzle. Having stopped the circulation pump for the predetermined time, the CPU 205 executes a process at S1008.

At S1008, the CPU 205 determines whether the anomaly having occurred to the liquid discharge apparatus is resolved. A well-known method may be used as a method of determining whether the anomaly is resolved. For example, the CPU 205 determines that the anomaly is resolved in a case where the operator presses down a restore button after removing a jamming paper sheet and the CPU 205 moves the discharge head to the standby position and caps the nozzle again. As another example, the CPU 205 determines that the anomaly is resolved in a case where the operator reactivates the liquid discharge apparatus and then the CPU 205 moves the discharge head to the standby position and caps the nozzle again. In a case where the anomaly is not resolved (NO at S1008), the CPU 205 executes the processes at S1004 to S1007 again. In a case where the anomaly is resolved (YES at S1008), the CPU 205 stops drive of the circulation pump and then executes a process at S1009.

At S1009, the CPU 205 obtains the temperature around the discharge head, which is sensed by the temperature sensor and the humidity around the discharge head, which is sensed by the humidity sensor 218. Having obtained the temperature and humidity around the discharge head, the CPU 205 executes a process at S1010.

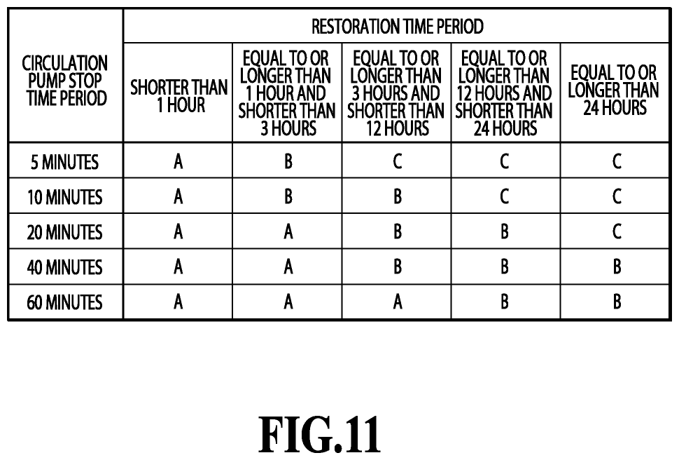

At S1010, the CPU 205 refers to a table illustrated in FIG. 11 and determines the contents of recovery operation. The procedure in FIG. 10 is processing performed in a case where anomaly has occurred during printing, for example. Liquid constantly circulates during printing in the present embodiment. Thus, ink circulation may be continued or temporarily stopped while the processes at S1001 to S1006 are performed. The processes at S1001 to S1006 are performed in a short time. Accordingly, it is unlikely that ink is firmly fixed and becomes difficult to circulate. In the present embodiment, the above-described procedure is not executed in a case where anomaly has occurred to the liquid discharge apparatus and it is difficult to move the carriage and drive the circulation pump. In this case, the liquid discharge apparatus is stopped. For example, in a case where it is determined to be difficult to normally operate the carriage motor and the circulation pump due to anomaly of an electric substrate, the above-described procedure is not executed and the liquid discharge apparatus is stopped.

### Recovery Operation

Recovery operation will be described below with reference to FIG. 11.

FIG. 11 is a diagram illustrating an example of a table listing the contents of recovery operation in the present embodiment. In FIG. 11, elapsed time from a time point at which anomaly occurs to the liquid discharge apparatus to a time point at which the nozzle surface is restored to a normally capped state is simply referred to as a “restoration time period”. A “circulation pump stop time period” corresponds to “T2” set based on the table illustrated in FIG. 9. In the present embodiment, the contents of recovery operation to be executed are determined in accordance with combination of the “restoration time period” and the “circulation pump stop time period”.

In a case where anomaly has occurred to the liquid discharge apparatus and the nozzle surface has not been capped for a relatively long time, water partially evaporates and liquid condenses in the circulation flow path of the discharge head. To resolve the liquid condensation, the condensed liquid is discharged and liquid is newly supplied.

The amount of liquid newly supplied in place of the condensed liquid (that is, the amount of replaced liquid) may be adjusted in accordance with the progress of liquid condensation in the circulation flow path. The amount of replaced liquid is the amount of water evaporated from liquid in the circulation flow path. The amount of evaporated water depends on the temperature and humidity around the discharge head. Accordingly, the amount of replaced liquid changes in accordance with the progress of liquid condensation in the circulation flow path.

As described above, the stop time period “T2” of the circulation pump is determined based on the table illustrated in FIG. 9. The contents of recovery operation performed after anomaly is resolved are determined based on combination of the stop time period “T2” of the circulation pump and the elapsed time from the time point at which anomaly occurs to the time point at which the nozzle surface is restored to the normally capped state.

In the case of “A” in FIG. 11, auxiliary discharge is performed as recovery operation. Specifically, liquid in the vicinity of the nozzle is discharged onto the cap.

In the case of “B” in FIG. 11, choke suction is performed one as recovery operation. The choke suction is as follows. In the present embodiment, negative pressure is generated at the nozzle by using the cap and the suction pumps to suck liquid. The discharge amount of liquid at suction is controlled by the number of times of suction operation. During generation of negative pressure at the nozzle, valves in the supply flow path are closed to suck liquid by generating negative pressure in the entire circulation flow path of the discharge head, and liquid in a volume corresponding the depressurization is replaced with non-condensed liquid supplied from the supply flow path. This is description of the choke suction.

In the case of “C” in FIG. 11, the above-described choke suction is performed twice as recovery operation.

As illustrated in FIG. 11, the contents of recovery operation in the present embodiment are determined based on combination of the stop time period “T2” of the circulation pump and the restoration time period.

In the case of “A” in FIG. 11, the restoration time period is relatively short and the amount of water evaporation is relatively small in the circulation flow path. Thus, in the case of “A” in FIG. 11, a printed image or liquid discharge performance is hardly affected by liquid condensation. Thus, only auxiliary discharge is performed as recovery operation in the case of “A” in FIG. 11. Accordingly, the discharge amount of liquid in this case is the amount of discharge through auxiliary discharge. The reason why auxiliary discharge is performed is to discharge liquid having a relatively high viscosity and thus not completely mixed in the flow path but remaining at an edge of the nozzle despite liquid circulation.

In the case of “B” or “C” in FIG. 11, the restoration time period is relatively long and the evaporation rate of water in the circulation flow path is relatively high. Thus, in the case of “B” or “C” in FIG. 11, a printed image or liquid discharge performance is potentially affected by liquid condensation. Accordingly, in the case of “B” or “C” in FIG. 11, the degree of condensation needs to be lowered by setting the discharge amount of liquid in the circulation flow path to be larger than the discharge amount of liquid discharged through auxiliary discharge. Thus, the choke suction is performed as recovery operation in the case of “B” or “C” in FIG. 11.

The replacement ratio of liquid in the circulation flow path is determined by the number of times of the choke suction. Thus, the choke suction needs to be executed by a number of times necessary for sufficiently resolving liquid condensation. In the case of “B” in FIG. 11, condensation can be resolved by performing the choke suction once. In the case of “C” in FIG. 11, condensation can be resolved by performing the choke suction twice.

The contents of recovery operation can be determined in accordance with the temperature and humidity around the discharge head by preparing a plurality of tables as in FIG. 11 for respective combinations of the temperature and humidity around the discharge head. Specifically, the contents of recovery operation can be determined in accordance with the temperature and humidity around the discharge head based on the stop time period of the circulation pump and a time period needed to resolve anomaly after the anomaly occurs.

Recovery operation is described above. The following describes processing performed by the CPU 205 with reference to FIG. 10 again. Having determined the contents of recovery operation, the CPU 205 executes a process at S1011.

At S1011, the CPU 205 executes recovery operation. Having completed execution of recovery operation, the CPU 205 ends the series of processes in the present procedure.

The above-described processing is executed by the CPU 205 in a case where anomaly has occurred to the liquid discharge apparatus.

### Conclusion

As described above, the liquid discharge apparatus in the present embodiment drives the circulation pump appropriately even in a case where anomaly occurs and the liquid discharge apparatus is left to stand for a relatively long time in a state in which the nozzle surface is not capped. Accordingly, agglomeration and fixation of liquid in the nozzle are reduced. Thus, image defect generation due to discharge defect of the nozzle is reduced.

According to the liquid discharge apparatus in the present embodiment, it is possible to excellently maintain discharge characteristics of the discharge head.

Moreover, according to the liquid discharge apparatus in the present embodiment, the contents of recovery operation are determined based on the stop time period of the circulation pump and a time taken for restoration after anomaly occurs. Accordingly, it is possible to optimize the amount of liquid discharged during recovery operation.

### Other Embodiments

Although the example illustrated in FIG. 1 is described by assuming a case where the printing medium 106 is a paper roll, the printing medium 106 is not limited to a paper roll. A “printing medium” includes not only a paper sheet used by a typical liquid discharge apparatus but also fabric, a plastic film, a metal plate, glass, ceramics, resin, wood, leather, and the like, which can receive ink.

In the example illustrated in FIG. 1, the liquid discharge apparatus 100 is what is called a serial-scanning-type printer but does not necessarily need to be a serial-scanning-type printer. The liquid discharge apparatus 100 may be, for example, a printer including what is called a line-type discharge head.

The liquid discharge apparatus 100 may be, for example, a single-function printer having only a printing function or a multifunction printer having a plurality of functions such as a printing function, a facsimile function, and a scanner function. The liquid discharge apparatus 100 may be a manufacturing apparatus for manufacturing a color filter, an electronic device, an optical device, a minute structure, or the like by a predetermined printing scheme.

In the example illustrated in FIG. 1, the carriage belt is used as a drive mechanism that transfers drive power from the carriage motor to the carriage 102. This is not the only example of the drive mechanism. The carriage belt may be replaced with another drive mechanism such as a mechanism configured to be rotationally driven by the carriage motor and including a lead screw extending in the X direction and an engagement part disposed on the carriage 102 and configured to engage with grooves of the lead screw.

In the example illustrated in FIG. 1, liquid is supplied from the liquid tank to the discharge head 101 by using a pressurization mechanism. As another example, liquid may be supplied from the liquid tank to the discharge head 101 by capping the nozzle surface and generating negative pressure in the cap by using the suction pumps to suck the liquid.

In the example illustrated in FIG. 2, the liquid tank 219 is disposed inside the liquid discharge apparatus 100. However, the liquid tank 219 may be disposed outside the liquid discharge apparatus 100 as long as liquid can be supplied to the discharge head 101.

In the example illustrated in FIG. 5, the circulation pump 216, the first pressure adjustment mechanism 501, and the second pressure adjustment mechanism 502 are disposed inside the discharge head 101 but may be disposed outside the discharge head 101 as long as liquid can be circulated.

In the example illustrated in FIG. 5, the circulation flow path configuration and the pressure adjustment mechanism for one kind of liquid are described. The liquid discharge apparatus may include circulation flow path configurations and pressure adjustment mechanisms corresponding to a plurality of kinds of liquid. In this case, the liquid discharge apparatus includes a first discharge head for discharging first liquid and a first circulation unit capable of circulating first liquid in a first circulation flow path including a first pressure chamber provided in the first discharge head. The liquid discharge apparatus further includes a second discharge head for discharging second liquid of a kind different from the first liquid and a second circulation unit capable of circulating the second liquid in a second circulation flow path including a second pressure chamber provided in the second discharge head. A control unit included in the liquid discharge apparatus controls the first circulation unit and the second circulation unit so that a time period in which circulation is performed and a time period in which circulation is stopped are different between the first circulation flow path and the second circulation flow path.

In the example illustrated in FIG. 6, the first wipers 603 and the second wiper 604 are elastic members such as rubber. As another example, the first wipers 603 and the second wiper 604 may be members made of a porous material that absorbs liquid.

A vacuum wiper capable of sucking the nozzle surface may be provided. Alternatively, wiping may be performed by pressing non-woven fabric against the nozzle surface by using a pressing member.

In the example illustrated in FIG. 6, wiping is performed by moving the first wipers 603 and the second wiper 604 in one direction. As another example, wiping may be performed by reciprocating the first wipers 603 and the second wiper 604 in both directions.

In the example illustrated in FIG. 6, the wiping direction is the array direction of the nozzle. As another example, the wiping direction may be a direction (disposition direction of the nozzle columns) intersecting (orthogonal to) the array direction of the nozzle. Specifically, the wiping direction may be the X direction instead of the Y direction in FIG. 6 as long as the nozzle surface can be wiped. Moreover, in this configuration, the first wipers 603 and the second wiper 604 may be fixed and the nozzle surface may be wiped by moving the carriage in the scanning direction (the X direction in the drawing). In a configuration in which a plurality of wiping members are provided or wiping is performed in different directions, the wiping members may be disposed at separated positions. In this case, the recovery mechanism 214 may be separately disposed in the vicinity of the standby position of the carriage and on the opposite side across a printing medium.

In the example illustrated in FIG. 9, the stop time period “T2” of the circulation pump is determined based on the temperature and humidity around the discharge head. Not only the stop time period “T2” of the circulation pump but also the drive time period “T1” of the circulation pump may be determined based on the temperature and humidity around the discharge head.

In the above description, based on both the temperature and humidity around the discharge head, the drive time period “T1” and the stop time period “T2” in intermittent circulation are set and the kind of recovery processing is determined, but the setting and the determination may be performed based on one of the temperature and the humidity.

At S1003 in FIG. 10, whether anomaly has occurred during discharge operation of the discharge head is determined by using a detection result of an encoder scale read by the encoder sensor. The method of determining whether anomaly has occurred during discharge operation of the discharge head is not limited to such a method using the encoder sensor. Whether anomaly has occurred during discharge operation of the discharge head may be determined by mounting an acceleration sensor in the carriage to sense acceleration of the discharge head during the discharge operation and detecting collision with a printing medium or the like.

In FIG. 10, the process at S1007 is performed after the process at S1006. As another example, the circulation pump may be continuously driven until anomaly is resolved instead of intermittently driven. For example, in the process at S1007, the stop time period of the circulation pump may be eliminated by setting “T2”=0. Then, the circulation pump may be stopped after anomaly is resolved (that is, after the process at S1008).

It is difficult to stop the circulation pump depending on characteristics of liquid in some cases. For example, it is difficult to stop the circulation pump in a case where liquid has such a characteristic that the viscosity of the liquid in the nozzle increases during stop of the circulation pump and it becomes difficult to flow the liquid even if the circulation pump is driven again.

Furthermore, the effect of reducing liquid evaporation, which is achieved by stopping the circulation pump decreases in a case where the stop time period of the circulation pump, with which it is possible to flow liquid by driving the circulation pump again, is too short. In such a case, the circulation pump may be continuously driven. By continuously driving the circulation pump to maintain a state in which liquid circulation can be continued, it is possible to prevent fixation of liquid in the nozzle even in a case where a state in which the nozzle surface is not capped continues for a relatively long time. Thus, it is possible to reduce water evaporation without periodically stopping drive of the circulation pump. With such a configuration, it is possible to excellently maintain discharge characteristics of the discharge head although the ratio of water decreases as indicated by the graph of the dotted line 803.

In the example illustrated in FIG. 9, the stop time period “T2” of the circulation pump is determined based on the temperature and humidity around the discharge head. The viscosity of liquid increases as the evaporation rate of water contained in the liquid increases. Thus, the frequency (“T2”, in effect) of drive of the circulation pump may be determined in accordance with the progress of water evaporation so that liquid has such a viscosity that flow is possible in a case where the circulation pump is driven again. For example, anomaly occurs to the liquid discharge apparatus under a condition that the temperature is 25° C. and the humidity is 50% RH, and the liquid discharge apparatus is stopped in a state in which the nozzle surface is not capped. In this case, the stop time period of the circulation pump is 20 minutes under a predetermined condition according to the table in FIG. 9. However, the evaporation rate of water may be predicted based on the temperature and humidity around the discharge head, and the stop time period “T2” of the circulation pump may be changed from 20 minutes to 10 minutes based on the predicted value. Thereafter, in a case where the predicted value of the evaporation rate of water gradually increases as time elapses, the stop time period “T2” of the circulation pump may be gradually shortened from 10 minutes to five minutes.

Even after anomaly is resolved and the nozzle surface is normally capped, water in the cap potentially slightly evaporates in the vicinity of the nozzle due to dryness in the cap or moisture absorption by thickened liquid. In such a case, the circulation pump may be periodically driven.

However, the volume of the cap is relatively small at several mL and the amount of water evaporation is small. Thus, the drive frequency of the circulation pump in this case is set to be lower than the drive frequency of the circulation pump in a case where the nozzle surface is not capped. For example, in a case where the nozzle surface is capped by the cap, a printing control unit causes the circulation pump to perform intermittent circulation at a first drive frequency. In a case where the nozzle surface is not capped by the cap, the printing control unit causes the circulation pump to perform intermittent circulation at a second drive frequency higher than the above-described first drive frequency.

As another example, in a case where the nozzle surface is capped by the cap, the printing control unit causes the circulation pump to perform intermittent circulation so that the ratio of the circulation time period and the stop time period is a first ratio. In a case where the nozzle surface is not capped by the cap, the printing control unit causes the circulation pump to perform intermittent circulation so that the ratio of the circulation time period and the stop time period is a second ratio with which the ratio of the stop time period relative to the circulation time period is larger than with the above-described first ratio. With the above-described configuration as well, it is possible to excellently maintain discharge characteristics of the discharge head.

As another example, in a case where transition occurs from a state in which the nozzle surface is not capped to a state in which the nozzle surface is capped, the printing control unit may control the circulation pump so that the ratio of the circulation time period and stop time period of the circulation pump transitions from the above-described second ratio to the above-described first ratio.

In the example of FIG. 11, the contents of recovery operation are determined based on the stop time period “T2” of the circulation pump and a time taken for restoration from anomaly. In other words, the amount of liquid discharged in recovery operation is controlled based on the stop time period “T2” of the circulation pump and a time period from a time point at which anomaly occurs to a time point of restoration from the anomaly. As another example, the actual temperature and the actual humidity in a state in which the nozzle surface is not capped may be periodically sensed and the amount of liquid discharged in recovery operation may be determined by calculating an accumulated evaporation water amount from a time point at which anomaly occurs to a time point of restoration from the anomaly.

The pace of water evaporation from the surface of liquid depends on temperature and humidity (saturation water vapor pressure) in surroundings. Thus, the amount of water lost from liquid in the discharge head can be predicted based on a time period in which the nozzle surface is not capped and the pace of water evaporation by correcting the pace of water evaporation based on the temperature and humidity around the discharge head. For example, the pace of water evaporation from the nozzle for one color may be determined based on an experiment value, and correction coefficients of temperature and humidity may be calculated by using a predetermined formula or a table.

In this manner, the printing control unit may predict the evaporation rate of liquid based on the temperature and humidity around the discharge head and a time period from a time point at which anomaly is detected to a time point at which the anomaly is resolved. Then, the printing control unit may use a result of the prediction to determine the drive frequency of the circulation pump when intermittently driven in accordance with elapsed time. Moreover, the printing control unit may use the prediction result and gradually increase the drive frequency of the circulation pump when intermittently driven in accordance with elapsed time. In addition, the printing control unit may determine the contents of recovery operation by using the prediction result.

The method of discharging liquid in recovery operation is not limited to the method of generating negative pressure at the nozzle by using the cap and the suction pumps but may be any method capable of discharging liquid. For example, liquid may be discharged from the nozzle 402 by using a mechanism configured to open the first valve 510 by pressing the first pressure plate 515 with a mechanical unit or air pressure. With such a mechanism as well, the first communication port 509 can be opened. Once the first communication port 509 is opened, liquid flows from the first valve chamber 508 to the first liquid chamber 504. Then, the liquid having entered from the first liquid chamber 504 to the pressure chamber 401 presses and discharges liquid accumulated in the vicinity of the nozzle. In a case where a plurality of kinds of ink are simultaneously sucked and discharged with one cap 601 while recovery operation is performed, a different kind of ink flows backward from the nozzle through the cap 601 and different kinds of ink are potentially mixed if the suction amount is different depending on the ink. In other words, ink mixed in color enters inside the circulation flow path in a case where circulation operation is performed even though what is called color mixture has occurred. Thus, circulation operation is stopped while suction recovery is performed.

In the above-described embodiments, ink is discharged as liquid, but liquid that can be used with the liquid discharge apparatus of the present disclosure is not limited to ink. Specifically, liquid may be various kinds of printing liquid including processing liquid used for improvement of ink fixability onto a printing medium, reduction of glazing unevenness, or improvement of abrasion resistance.

In the above-described embodiments, the anomaly detection unit detects anomaly having occurred during liquid discharge operation. However, the anomaly detection unit is not limited to this example as long as anomaly having occurred anywhere except for the standby position can be detected. For example, the anomaly detection unit may be a sensor mounted on the carriage and capable of detecting a paper jam having occurred in a case where the carriage is moved to sense the width of a printing medium.

In the example illustrated in FIG. 5, the circulation flow path includes the pressure chamber 401 and is formed to circulate liquid between the first pressure adjustment mechanism 501 and the second pressure adjustment mechanism 502. However, the circulation flow path is not limited to this example of a flow path including a pressure chamber, but may be any flow path through which liquid supplied from the first liquid chamber to the second liquid chamber different from the first liquid chamber can be collected to the first liquid chamber and supplied from the first liquid chamber to the second liquid chamber again.

Not all combinations of characteristics described above in the embodiments are necessarily essential to unit for solution of the present disclosure. The relative positions, shapes, and the like of components described in the above-described embodiments are merely exemplary. The technical scope of the present disclosure is not limited thereto.

According to the liquid discharge apparatus of the present disclosure, it is possible to excellently maintain discharge characteristics of the discharge head.

Embodiment(s) of the present disclosure can also be realized by a computer of a system or apparatus that reads out and executes computer executable instructions (e.g. one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-009725, filed Jan. 25, 2023, which is hereby incorporated by reference wherein in its entirety.

What is claimed is:

1. A liquid discharge apparatus comprising:
a discharge head including a nozzle for discharging liquid, an energy generation element for generating energy used to discharge liquid, and a pressure chamber that is a space facing the energy generation element;
a circulation unit configured to circulate liquid through a circulation flow path including the pressure chamber of the discharge head;
a cap unit configured to cap a nozzle surface of the discharge head where the nozzle is formed; and
a control unit for controlling the discharge head and the circulation unit, wherein
in a case where anomaly is detected during discharge operation of the discharge head and the cap unit cannot cap the nozzle surface, the control unit causes the circulation unit to circulate liquid through the circulation flow path, and
in a case where anomaly is detected during discharge operation of the discharge head and the cap unit can cap the nozzle surface, the control unit does not cause the circulation unit to circulate liquid through the circulation flow path.

2. The liquid discharge apparatus according to claim 1, wherein the circulation flow path includes
a first pressure adjuster capable of adjusting the pressure of liquid,
a supply flow path for supplying liquid from the first pressure adjuster to the pressure chamber,
a second pressure adjuster capable of adjusting the pressure of liquid, and
a collection flow path for collecting liquid from the pressure chamber to the second pressure adjuster.

3. The liquid discharge apparatus according to claim 2, wherein
the discharge head discharges liquid while moving in a predetermined direction, and
the circulation flow path and the circulation unit move in the predetermined direction together with the discharge head.

4. The liquid discharge apparatus according to claim 3, wherein the control unit determines whether the nozzle surface is capped by the cap unit based on position information of the discharge head in the predetermined direction and information related to operation of a cam mechanism for moving up and down the cap unit.

5. The liquid discharge apparatus according to claim 1, wherein in a case where the anomaly is resolved, the control unit causes the circulation unit to stop liquid circulation.

6. The liquid discharge apparatus according to claim 1, wherein the control unit causes the circulation unit to execute intermittent circulation in which circulation and stop are alternately performed between a time point at which the anomaly is detected and a time point at which the anomaly is resolved.

7. The liquid discharge apparatus according to claim 6, wherein in the intermittent circulation, a stop time period is longer than a circulation time period.

8. The liquid discharge apparatus according to claim 6, wherein
in a case where the nozzle surface is capped by the cap unit, the control unit causes the circulation unit to perform liquid circulation at a first frequency in the intermittent circulation, and
in a case where the nozzle surface is not capped by the cap unit, the control unit causes the circulation unit to perform liquid circulation at a second frequency higher than the first frequency in the intermittent circulation.

9. The liquid discharge apparatus according to claim 8, wherein
in a case where the nozzle surface is capped by the cap unit, the control unit causes the circulation unit to perform the intermittent circulation so that a ratio of a circulation time period and a stop time period is a first ratio, and
in a case where the nozzle surface is not capped by the cap unit, the control unit causes the circulation unit to perform the intermittent circulation so that the ratio of the circulation time period and the stop time period is a second ratio with which the ratio of the stop time period relative to the circulation time period is larger than with the first ratio.

10. The liquid discharge apparatus according to claim 9, wherein in a case where transition has occurred from a state in which the nozzle surface is not capped by the cap unit to a state in which the nozzle surface is capped by the cap unit, the control unit controls the circulation unit so that the ratio of the circulation time period and the stop time period transitions from the second ratio to the first ratio.

11. The liquid discharge apparatus according to claim 6, wherein
the liquid discharge apparatus includes
a first discharge head for discharging first liquid,
a first circulation unit capable of circulating the first liquid through a first circulation flow path including the pressure chamber of the first discharge head,
a second discharge head for discharging second liquid, and
a second circulation unit capable of circulating the second liquid through a second circulation flow path including the pressure chamber of the second discharge head, and
the control unit controls the first circulation unit and the second circulation unit so that a time period in which circulation is performed and a time period in which circulation is stopped are different between the first circulation flow path and the second circulation flow path.

12. The liquid discharge apparatus according to claim 6, wherein the control unit determines the stop time period of circulation in the intermittent circulation based on at least one of temperature and humidity around the discharge head.

13. The liquid discharge apparatus according to claim 12, wherein the control unit determines, based on an elapsed time from a time point at which the anomaly is detected to a time point at which the anomaly is resolved, the frequency of circulation in the intermittent circulation to be executed by the circulation unit after the anomaly is resolved.

14. The liquid discharge apparatus according to claim 13, wherein the control unit determines the frequency of circulation in the intermittent circulation to be higher as the elapsed time is longer.

15. The liquid discharge apparatus according to claim 6, wherein the control unit determines the stop time period of circulation in the intermittent circulation based on at least one of temperature and humidity in the vicinity of the nozzle.

16. The liquid discharge apparatus according to claim 13, further comprising
a recovery mechanism for recovering a discharge state of the discharge head, wherein
the control unit determines contents of recovery operation to be executed by the recovery mechanism based on an elapsed time from a time point at which the anomaly is detected to a time point at which the anomaly is resolved.

17. The liquid discharge apparatus according to claim 1, wherein the control unit causes the circulation unit to continuously circulate liquid through the circulation flow path while the discharge head is discharging liquid onto a printing medium.

18. The liquid discharge apparatus according to claim 17, wherein in a case where anomaly is detected during discharge operation of the discharge head and the cap unit can cap the nozzle surface, the control unit causes the circulation unit to stop liquid circulation through the circulation flow path.

19. A method of controlling a liquid discharge apparatus including a discharge head, a circulation unit, and a cap unit, the discharge head including a nozzle for discharging liquid and a pressure chamber that communicates with the nozzle and can be filled with liquid, the discharge head being capable of discharging the liquid with which the pressure chamber is filled from the nozzle, the circulation unit being capable of circulating liquid through a circulation flow path including the pressure chamber, the cap unit being capable of capping a nozzle surface of the discharge head where the nozzle is formed, the method comprising:
detecting anomaly;
determining whether the nozzle surface is capped by the cap unit; and
circulating liquid through the circulation flow path in a case where the anomaly is detected in detecting anomaly and it is determined that nozzle surface is not capped by the cap unit.

20. The control method according to claim 19, wherein in the circulation, liquid circulation through the circulation flow path and stop are alternately performed.
